(19) United States
(12) Patent Application Publication
(10) Pub. No.: US 2019/0206614 A1
(43) Pub. Date: Jul. 4, 2019

(54) PHASE-SHIFTING SINUSOIDAL COMMUTATION WITH OPTIONAL ROTARY TRANSFORMER

(71) Applicant: Jordan James McBain, Davisburg, MI (US)

(72) Inventor: Jordan James McBain, Davisburg, MI (US)

(73) Assignee: Dogged Mechatronics LLC, Davisburg, MI (US)

(21) Appl. No.: 15/859,658

(22) Filed: Dec. 31, 2017

(51) Int. Cl. H01F 30/12; H02P 9/30; H02K 3/28; H01F 38/14

(52) U.S. Cl. CPC H01F 30/12; H02P 9/305; H01F 2038/143; H01F 38/14; H02K 3/28

(57) ABSTRACT

The apparatus employs magnetoresistive sensors (28) to generate a sinusoid having a time-varying instantaneous frequency commensurate with the instantaneous frequency of the angular displacement of a motor's rotating shaft (40). The resultant signal is then fed to a mixture of fixed-phase-shifting circuits (22) whose outputs are then amplified by voltage-controlled amplifiers and fed to independently wired stator phases (56).

This application claims the benefit of the provisional application Ser. No. 62/437,644 filed 21 Dec. 2016.

### BACKGROUND OF THE INVENTION

### 1. Field of the Invention

An apparatus for phase-shifting sinusoidal commutation.

### 2. Description of the Prior Art

An apparatus for motor commutation is well known to consist of a stator system, a rotating shaft being rotatably mounted in the stator system, one or more rotor magnets, having a magnetic field with a magnetic polarization, being affixed to the rotating shaft such that the rotor magnet's magnetic polarization is not parallel with the rotating shaft's axis of rotation. One or more stator phases are also necessary—each stator phase consisting of electromagnets having electrical leads at opposing ends of windings of insulated electrically conductive material, one lead being electrically continuous with the other, that are mechanically affixed to the stator system and disposed about the rotor magnet(s) to deliver an electromagnetic force onto the rotor magnet(s) when electric current is applied to the stator phases.

A shaft sinusoid generating circuit, having output terminals which are connected to electrical components that generate an electrical signal having sinusoidal form whose instantaneous frequency is commensurate with the instantaneous frequency of the rotating shaft's angular displacement, is also well established in the prior art in such technologies as magneto-resistive sensors.

Prior art, apparently disjoint from motor commutation technology, also consists of phase-shifting circuits being formed of input terminals, output terminals and electrical circuitry which generates a phase-shifted version of the signal applied to its input terminals at its output terminals.

### SUMMARY OF THE INVENTION

This invention employs a phase-shifting and control circuit being formed of input terminals, output terminals, and electrical components generating current capable of causing a magnetic field in a motor's stator phases to cause its rotating shaft to rotate when the stator phases are connected to the output terminals of a phase-shifting and control circuit. The phase-shifting and control circuit routes the signal of a shaft sinusoid generating circuit through one or more phase-shifting circuit(s) which is in turn amplified and otherwise conditioned prior to being supplied to one or more of the stator phases.

### ADVANTAGES OF THE INVENTION

The purported optimal means of commutating a motor is achieved by employing sinusoidal commutation which is reported to provide smooth torque and linear motion control similar to brushed motors without the disadvantages of brushed commutation. Unfortunately, present implementations of sinusoidal commutation do not work well for motors spinning at high speeds. This deficit has generated other techniques such as space-vector modulation which utilizes complex computational algorithms.

The invention in its broadest aspect provides for motor commutation achieved via phase-shifting technology.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an electrical schematic of the proposed circuit.

### DESCRIPTION OF THE ENABLING EMBODIMENT

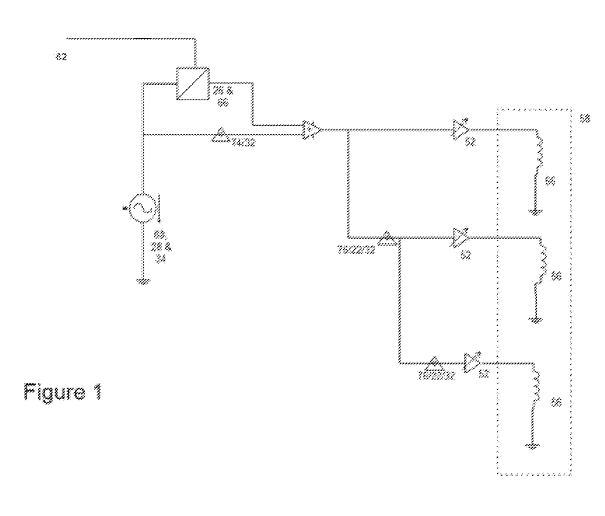

Referring to the FIG. 1, wherein like numerals indicate corresponding parts throughout the several views, enabling embodiments of an apparatus for phase-shifting sinusoidal commutation constructed in accordance with the subject invention are illustrated. Italicization is applied as stylistic choice throughout the document to ease the reader's review and is in no way meant to be limiting.

The apparatus includes a stator system having three electrical coils—each coil acting as a first, second and third electrical phase. A rotating shaft is rotatably mounted within the stator system; the stator system generates magnetic fields that act on a rotor magnet which is mechanically affixed to the rotating shaft. The rotor magnet can be an electromagnet formed of windings of electrically conductive material having two leads at opposing extremes each being electrically continuous with the other forming its input terminals. The rotor magnet is affixed to the rotating shaft. The rotor magnet is mechanically affixed on the rotating shaft at the intersection of the rotating shaft and the plane formed from the electrical phases which are dispersed with angularly equidistant spacing about the rotor electromagnet at right angles to the rotating shaft.

The primary basis of this invention is a shaft sinusoid generating circuit having output terminals which are connected to electrical components generating an electrical signal having sinusoidal form whose instantaneous frequency is commensurate with the instantaneous frequency of the rotating shaft's angular displacement. The second basis of the invention is found in a phase-shifting circuit that is formed of input terminals, output terminals and electrical circuitry which generates a phase-shifted version of the signal applied to the phase-shifting circuit's input terminals at its output terminals. The technology underlying the phase shifting circuit is a well-known clement in the state of the art as described in such teachings as U.S. Pat. No. 4,122,364 A and in: Poon and Taghivand. Supporting and Enabling Circuits for Antenna Arrays in Wireless Communications, Proceedings of the IEEE, Vol 100, No. 7, pp 2207-2218, July 2012 (DOI 10.1109/JPROC.2012.2186949).

Each electrical phase is excited by a phase-shifting and control circuit being formed of input terminals, output terminals, and electrical components generating an amplified, electrically conditioned and phase-shifted version of the signal generated from the shaft sinusoid generating circuit having current capable of causing a magnetic field in the stator phases to cause the rotating shaft to rotate when an electromagnetic field is present on the rotor magnet. To generate a phase shift, the phase-shifting and control circuit is constituted in part by one or more phase-shifting circuits.

A voltage command line is configured to receive a voltage level indicating a command for the stator phases to apply an electromagnetic force to the rotor magnet's electromagnetic field which is also initiated by voltage applied on the voltage command line.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. An apparatus for phase-shifting sinusoidal commutation including;
a stator system (58),
a rotating shaft (40) being rotatably mounted in said stator system (58),
one or more rotor magnets (44) having a magnetic field with a magnetic polarization, one or more of said rotor magnets (44) being affixed to said rotating shaft (40) such that said rotor magnet's (44) magnetic polarization is not parallel with said rotating shaft's (40) axis of rotation,
one or more stator phases (56) consisting of electromagnets having electrical leads at opposing ends of windings of insulated electrically conductive material with one lead being electrically continuous with the other,
one or more of said stator phases (56) being mechanically affixed to said stator system (58) and being disposed about said rotor magnet(s) (44) to deliver an electromagnetic force onto said rotor magnet(s) (44) when electric current is applied to said stator phases (56),
a shaft sinusoid generating circuit (68) having output terminals which are supplied by electrical components that generate an electrical signal having sinusoidal form whose instantaneous frequency is commensurate with the instantaneous frequency of the angular displacement of the rotating shaft (40),
one or more phase-shifting circuits (32) being formed of input terminals, output terminals and electrical circuitry which generates a phase-shifted version of the signal applied to said input terminals of said phase-shifting circuit (32) at said phase-shifting circuit's (32) output terminals,
and characterized by,
a phase-shifting and control circuit (66) being formed of input terminals, output terminals, and electrical components generating current capable of causing a magnetic field in said stator phases (56) to cause said rotating shaft (40) to rotate when said stator phases (56) are connected to the output terminals of said phase-shifting and control circuit (66),
said phase-shifting and control circuit (66) having one or more phase-shifting circuits (32),
said input terminals of said phase-shifting and control circuit (66) being connected to the output terminals of said shaft sinusoid generating circuit (68) whose signal is routed through one or more of said phase-shifting circuits (32),
said output terminals of said phase-shifting and control circuit (66) being connected to the leads of one or more of said stator phases (56) and providing a phase-shifted, amplified and otherwise conditioned version of the signal from said shaft sinusoid generating circuit (68) to said stator phases (56).

2. An apparatus as set forth in claim 1 including:
a voltage command line (62) consisting of an input terminal receiving a voltage level indicating a command for said stator phases (56) to apply torque to said rotating shaft (40),
an initiating-and-sustaining circuit being constituted to generate an electrical signal during periods when the angular rate of change of said rotating shaft (40) nears zero resulting in the absence of a signal from said shaft sinusoid generating circuit (68) provided said voltage command line (62) receives a voltage level commanding torque be applied to said rotating shaft (40),
one or more stator amplifying stages (52) consisting of input terminals, output terminals and electrical components generating an amplified version of an electrical signal applied to said input terminals of said stator amplifying stages (52) at said stator amplifying stages' (52) output terminals,
and characterized by,
said phase-shifting and control circuit (66) including said voltage command line (62), said initiating-and-sustaining circuit,
said phase-shifting and control circuit (66) being comprised of electrical components and being connected so as to sum the voltages of the output terminals of said initiating-and-sustaining circuit with the voltages of said output terminals of said phase-shifting circuits (32), in turn connected to other phase-shifting circuits (32), the results of which are amplified and connected to one or more of said stator amplifying stages (52).

3. An apparatus as set forth in claim 2 where said initiating-and-sustaining circuit includes a local oscillator generating a sinusoidal electrical signal that is switched off and on according to said voltage command line (62) and the state of said shaft sinusoid generating circuit (68).

4. An apparatus as set forth in claim 1 including said shaft sinusoid generating circuit (68) being comprised of a magnetoresistive sensor (28) (for instance NXP KMZ60).

5. An apparatus as set forth in claim 1 including one or more of said phase-shifting circuit(s) (32) being formed from a voltage-controlled phase shifting circuit (64) (32).

6. An apparatus as set forth in claim 5 including one or more of said phase-shifting circuit(s) (32) being partially comprised of voltage-controlled capacitors and voltage-controlled inductors.

7. An apparatus as set forth in claim 2 further including:
A plurality of fixed-phase-shifting circuits (22), being comprised by said phase-shifting circuits (32), having input terminals, output terminals and electrical circuitry to supply a phase shifted version of an electrical signal applied to said input terminals of said fixed-phase-shifting circuit (22) at said output terminals of said fixed-phase-shifting circuit (22),
one or more stator amplifying stages (52) consisting of input terminals, output terminals and electrical circuitry generating an amplified version of an electrical signal applied to said input terminals of said stator amplifying stages (52) at said stator amplifying stage's (52) output terminals,
one or more stator amplifying stages (52) having a voltage command line (62) causing said stator amplifying stage (52) to vary the amount of amplification created by said stator amplifying stage (52) depending on the voltage applied to said voltage command line (62),
and characterized by,
each stator phase (56) being electrically connected to one or more stator amplifying stages (52) where each of said stator amplifying stages' (52) input terminals are electrically connected to the output terminals of one of said fixed-phase-shifting circuits (22) which are either connected to others of said fixed-phase-shifting circuits (22) or to said phase-shifting and control circuit (66).

11. An apparatus for phase-shifting sinusoidal commutation including:
a stator system (58) having three electrical coils, each coil acting as a first, second and third stator phase (56),
a rotating shaft (40) rotatably mounted within said stator system (58),
one or more rotor magnets (44) having a magnetic field with a magnetic polarization,
said stator phases (56) of said stator system (58) being disposed in a plane at right angles to said rotating shaft (40) and being dispersed within this plane at angularly equidistant spacing,
said rotor electromagnet (42) being mechanically affixed on said rotating shaft (40) at the intersection of said rotating shaft (40) and the plane formed by said stator phases (56),
voltage command line (62) being configured to receive a voltage level indicating a command for said stator phases (56) to apply an electromagnetic force to said rotating shaft (40),
a shaft sinusoid generating circuit (68) having output terminals which are connected to electrical components generating an electrical signal having sinusoidal form whose instantaneous frequency is commensurate with instantaneous frequency of the angular displacement of said rotating shaft (40),
one or more phase-shifting circuits (32) being formed of input terminals, output terminals and electrical circuitry which generates a phase-shifted version of the signal applied to said input terminals of said phase-shifting circuit (32) at said phase-shifting circuit (32)'s output terminals,
and characterized by,
a phase-shifting and control circuit (66) being formed of input terminals, output terminals, and electrical components generating an amplified, electrically conditioned and phase-shifted version of the signal generated from said shaft sinusoid generating circuit (68) with current capable of causing a magnetic field in said stator phases (56) to cause said rotating shaft (40) to rotate when said stator phases (56) are connected to the output terminals of said phase-shifting and control circuit (66), when an electromagnetic field is present on said rotor electromagnet (42),
said phase-shifting and control circuit (66) being constituted in part by one or more phase-shifting circuits (32) receiving the signal of said shaft sinusoid generating circuit (68),
said stator phases (56) being connected to said output terminals of said phase-shifting and control circuit (66).

12. An apparatus for phase-shifting sinusoidal commutation described in claim 11 including:
a positioning magnet (34) being affixed to the axial extreme of said rotating shaft (40) and having a magnetic field with an orientation that will cause said positioning magnet (34) to generate a time-varying magnetic field at the axial extreme of said rotating shaft (40) to which said positioning magnet (34) is affixed when said rotating shaft (40) has a varying angular position,
a magnetoresistive sensor (28) consisting of magnetoresistive material and electrical circuitry to generate a frequency-varying electrical sinusoid whose instantaneous frequency is commensurate with the rate of change of the magnetic field applied across said magnetoresistive sensor's (28) magnetoresistive material,
said magnetoresistive sensor (28) being disposed along the axis of said rotating shaft (40) at the same extreme to which said positioning magnet (34) is affixed but so as to be mechanically decoupled from said rotating shaft (40) and being disposed to be susceptible to the magnetic field of said positioning magnet (34),
said shaft sinusoid generating circuit (68) being constituted in part by said positioning magnet (34) and said magnetoresistive sensor (28).

13. An apparatus for phase-shifting sinusoidal commutation described in claim 11 including:
one or more phase-shifting circuits (32) being comprised of a voltage-controlled phase shifting circuit (64) (32) having a voltage/phase command line, input signal terminals, output signal terminals,
said voltage-controlled phase shifting circuit (64) (32) having electrical components to provide a phase shifted version of the electrical signal supplied to said input signal terminals of said voltage-controlled phase shifting circuit (64) (32) at said voltage-controlled phase shifting circuit's (64) (32) output signal terminals, the phase shift of which varies with the voltage level supplied at said voltage/phase command line,
two fixed phase shifting circuits (22) (32) having input terminals, output terminals and electrical circuitry to supply a phase shifted version of an electrical signal applied to said input terminals of said fixed phase shifting circuit (22) (32) at said output terminals of said fixed phase shifting circuit (22) (32),
one or more stator amplifying stages (52) consisting of input terminals, output terminals and electrical circuitry generating an amplified version of an electrical signal applied to said input terminals of said stator amplifying stages (52) at said stator amplifying stage's (52) output terminals,
and characterized by,
the fixed phase shift induced by each of said fixed phase shifting circuits (22) (32) being one hundred and twenty degrees,
an initiating-and-sustaining circuit being constituted in order for it to generate a time-varying electrical signal during periods when the angular rate of change of said rotating shaft (40) nears zero resulting in the absence of a signal from said shaft sinusoid generating circuit (68), provided said voltage command line (62) receives a voltage level commanding torque be applied to said rotating shaft (40),
said phase-shifting and control circuit (66) being comprised in part by said voltage-controlled phase shifting circuit (64) (32), said fixed phase shifting circuits (22) (32) and said stator amplifying stages (52),
one electrical phase being configured to receive current generated by amplifying the sum of said initiating-and-sustaining circuit and the output of said voltage-controlled phase shifting circuit (64) (32) when said input terminals of said voltage-controlled phase shifting circuit (64) (32) are supplied by said output terminals of said shaft sinusoid generating circuit (68), this electrical phase being the first electrical phase,
one electrical phase adjacent to said first electrical phase being electrically connected with the amplified result of the output terminals of the first of said fixed phase shifting circuits (22) (32) when the input terminals of said fixed phase shifting circuits (22) (32) are connected to the sum of said output terminals of said initiating-and-sustaining circuit and the output terminals of said voltage-controlled phase shifting circuit (64) (32) when said input terminals of said voltage-controlled phase shifting circuit (64) (32) are supplied by said output terminals of said shaft sinusoid generating circuit (68),
the last electrical phase being electrically connected to the amplified result of the output terminals of the remaining fixed phase shifting circuits (22) (32) when the input terminals of said remaining fixed phase shifting circuits (22) (32) are connected to the output terminals of said first fixed phase shifting circuit (22) (32).

16. A method for controlling the speed of the phase-shifting sinusoidal commutation apparatus described in claim 11 characterized by varying the voltage of said voltage/phase command line to vary the amount of torque generated by said stator phases (56) with a voltage applied to said voltage command line (62) commanding the activation of said stator phases (56).
